(19) United States
(12) Patent Application Publication
(10) Pub. No.: US 2023/0323674 A1
(43) Pub. Date: Oct. 12, 2023

(54) Window Shutter System

(71) Applicants: Steven Hamel, Pineville, LA (US); Rebecca Hamel, Pineville, LA (US)

(72) Inventors: Steven Hamel, Pineville, LA (US); Rebecca Hamel, Pineville, LA (US)

(21) Appl. No.: 18/296,497

(22) Filed: Apr. 6, 2023

Related U.S. Application Data
(60) Provisional application No. 63/329,082, filed on Apr. 8, 2022.

(51) Int. Cl. E04F 13/08

(52) U.S. Cl. CPC E04F 13/0803; E04F 13/0882; E04F 13/0883

(57) ABSTRACT

A window shutter system is provided primarily comprised of a frame, a window shutter cover, and a window shutter base. The frame is primarily comprised of a vertical member and a horizontal member and are oriented in a “H” like fashion. The frame is also comprised of at least one fastener that attaches to a reciprocating fastener located on the window shutter base. The fasteners on the window shutter base are located within the recessed area and allow the window shutter base to be attached to the frame. The window shutter cover is attached to the window shutter base via at least one fastener located on the inside surface of the window shutter cover. The system provides a way for a user to replace old or damaged shutters with minimal effort.

### CROSS-REFERENCE TO RELATED APPLICATION

The present application claims priority to, and the benefit of, U.S. Provisional Application No. 63/329,082, which was filed on Apr. 8, 2022, and is incorporated herein by reference in its entirety.

### FIELD OF THE INVENTION

The present invention relates generally to the field of window shutters. More specifically, the present invention relates to a window shutter system that allows a user to remove and replace window shutters with minimal effort and allows a user to customize their shutters by providing them with an easy way to attach and detach the shutters from the system. Accordingly, the present disclosure makes specific reference thereto. Nonetheless, it is to be appreciated that aspects of the present invention are also equally applicable to other like applications, devices and methods of manufacture.

### BACKGROUND

Many homes have window shutters. These shutters can often become damaged due to adverse weather conditions or time spent in the sunlight. When shutters become damaged, they can decrease the values of a home if they are not repaired. Further, damaged shutters can be an eyesore for the occupants of the house and neighbors. However, it can take a substantial amount of time for an individual to repaint their damaged shutters. It also may cost someone a significant amount of money to replace the shutters. In addition, wood shutters also rot as time progresses, forcing the majority of individuals to either repaint or replace their shutters. Because of how time consuming and expensive it can be to repair or replace shutters many individuals will live with the eyesore of rotted shutters. It can also be expensive and time consuming for an individual to interchange their shutters if they want to change them.

Therefore, there exists a long-felt need in the art for an improved window shutter. There also exists a long-felt need in the art for a window shutter system that provides users with a convenient way to replace damaged or old shutters. In addition, there also exists a long-felt need in the art for a window shutter system that prevents users from having to continually paint over old, damaged shutters or must seek out professional help to fix the shutters. There also exists a long-felt need in the art for a shutter that can be tailored and customized to the individual's wants and needs. Further, there exists a long-felt need in the art for a window shutter system that promotes easy self-repair of the home.

The subject matter disclosed and claimed herein, in one embodiment thereof, comprises a window shutter system. The system is preferably comprised of at least one frame, at least one window shutter base, and at least one window shutter cover. The frame is comprised of at least one vertical member and at least one horizontal member, wherein the vertical members are comprised of at least one fastener that allows the window shutter base to be removably attached to the frame. In one embodiment, the window shutter base is comprised of shutters. In another embodiment, the window shutter base is comprised of fasteners that allow the window shutter cover to be attached to the base.

In this manner, the window shutter system of the present invention accomplishes all of the forgoing objectives and provides an improved window shutter that can be easily replaced. In addition, the ease of replacement prevents users from having to continually paint over old, damaged shutters or must seek out professional help to fix the shutters. The device also allows a user to install tailored shutters customized to the individuals wants and needs.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a window shutter system. The system is preferably comprised of at least one frame, at least one window shutter base, and at least one window shutter cover. The system is preferably manufactured from a weatherproof UV resistant material, and may be any shape known in the art.

The frame is further comprised of at least one vertical member and at least one horizontal member. These members are preferably oriented in a “H” like fashion. The frame is further comprised of at least one mounting fastener that anchors the frame to the wall. Further, the frame is comprised of at least one fastener that connects to the reciprocating fastener located on the window shutter base to attach the two components.

The window shutter base is further comprised of at least one recessed area that houses at least one fastener that connects to the reciprocating fasteners located on the frame. The window shutter base is further comprised of a front surface, further comprised of at least one shutter. The window shutter base may be manufactured in any color or any orientation that the user desires.

The window shutter cover is comprised of an inside surface, at least one fastener, and a front surface, further comprised of at least one shutter. The fasteners are located on the inside surface of the window shutter cover and attach to the edges of the window shutter base. This provides a user with a way to attach and detach the window shutter base with minimal effort.

In one embodiment, there is no window shutter cover, and the window shutter base acts as the detachable shutter component. In another embodiment, the window shutter cover is the detachable shutter component, and the window shutter base is just an attachment member that the window shutter cover attaches to.

Accordingly, the window shutter system of the present invention is particularly advantageous as it provides a user with a customizable shutter system. The system provides a user with a convenient way to replace damaged/old shutters without having to spend precious time and/or money to replace them. In this manner, the window shutter system overcomes the limitations of existing window shutters known in the art.

Numerous benefits and advantages of this device will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a frame of one potential embodiment of a window shutter system of the present invention while attached to a wall in accordance with the disclosed architecture;

FIG. 2 illustrates a perspective view of a window shutter base of one potential embodiment of a window shutter system of the present invention while attached to a frame that is attached to a wall in accordance with the disclosed architecture;

FIG. 3 illustrates a rear perspective view of a window shutter cover of one potential embodiment of a window shutter system of the present invention in accordance with the disclosed architecture; and

FIG. 4 illustrates a side view of a frame of one potential embodiment of a window shutter system of the present invention while attached to a wall in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved window shutter system. There also exists a long-felt need in the art for a window shutter system that provides users with a convenient way to replace damaged or old shutters. In addition, there exists a long-felt need in the art for a window shutter system that prevents users from having to continually paint over old, damaged shutters or must seek out professional help to fix the shutters. There also exists a long-felt need in the art for a shutter that can be tailored and customized to the individuals wants and needs. Further, there exists a long-felt need in the art for a window shutter system that promotes easy self-repair of the home.

The present invention, in one exemplary embodiment, is comprised of a window shutter system. The system is further comprised of a frame, a window shutter base and a window shutter cover. The frame is primarily comprised at least one vertical member, at least one horizontal member, and at least one fastener. The frame is further fastened to the wall via at least one mounting fastener. The window shutter base is further comprised of a frame, at least one recessed area, at least one fastener, and a front surface, further comprised of at least one shutter. The window shutter base is further fastened to the frame via the fasteners located in the recessed area. The window shutter cover is comprised of a frame, at least one fastener located on the inside surface, and at least one front surface, further comprised of at least one shutter.

The window shutter cover may be attached to the window shutter base via the fasteners located in the window shutter cover. The ability to easily attach and detach the window shutter cover allows a user the ability to customize and change their shutters as they please. Further, the system may be manufactured form any waterproof UV resistant material known in the art. This helps protect the shutter from adverse weather conditions and may prevent a user from having to purchase new shutters.

Accordingly, the window shutter system of the present invention is particularly advantageous as it provides a user with a customizable shutter system. The system provides a user with a convenient way to replace damaged or old shutters without having to spend precious time and/or money to replace them. In this manner, the window shutter system overcomes the limitations of existing window shutters known in the art.

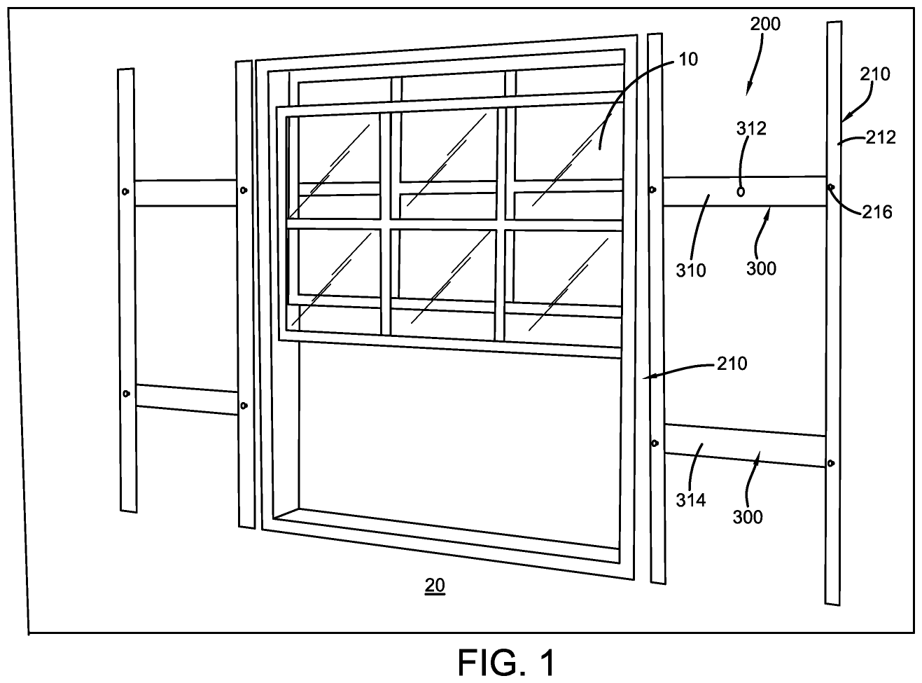

Referring initially to the drawings, FIG. 1 illustrates a perspective view of a frame of one potential embodiment of a window shutter system 100 of the present invention while attached to a wall 20 in accordance with the disclosed architecture. The system 100 is preferably comprised of at least one frame 200, at least one window shutter base 500, and at least one window shutter cover 600.

The system 100 is primarily comprised of a frame 200 comprised of at least one vertical member 210, at least one horizontal member 300, and at least one fastener 216. The frame 200 is attached to a wall 20 (i.e., the exterior of a home) in order to secure the window shutter base 500 to the wall 20. The vertical members 210 and the horizontal members 300 can be arranged in any orientation, but in the preferred embodiment, they are oriented in a “H” like fashion. The vertical members 210 run parallel to the sides of the window 10 while the horizontal members 300 run perpendicular to the sides of the window 10. The horizontal members 300 add additional stability to the frame 200 to prevent the window shutter base 500 from falling/becoming unattached from the wall 20 during adverse weather conditions.

The horizontal members 300 and vertical members 200 may be manufactured from any material known in the art such as but not limited to: wood, metal, plastic, etc. In the preferred embodiment, the frame 200 is manufactured from a weatherproof material or be comprised of a weatherproof coating and from a UV-resistant plastic. This may be any waterproof material or coating known in the art. In one embodiment, there are only vertical members 200 and not horizontal members 300. In another embodiment, there are both horizontal members 300 and vertical members 200 for added stability.

The system has at least one fastener 216 that is preferably located top surface 212 of the vertical members 200. The fasteners 216 allow the window shutter base 500 to be removably attached to the frame 200. The fasteners 216 used may be any fastener known in the art such as but not limited to: hook and loop, magnetic, snap button, adhesive, nut and bolt, tongue and groove, etc. In another embodiment, the top surface 310 of the horizontal members 300 may be comprised of at least one fastener 312 that further adds support between the window shutter base 500 and the frame 200. The fasteners 312 used may be any fasteners known in the art such as but not limited to: hook and loop, magnetic, snap button, adhesive, nut and bolt, tongue and groove, etc.

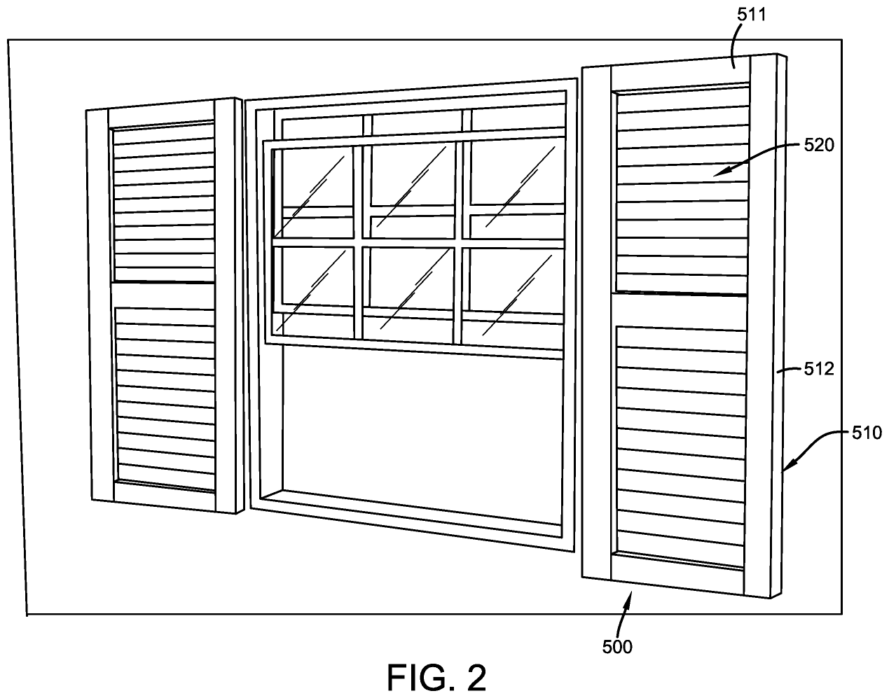

FIG. 2 illustrates a perspective view of a window shutter base 500 of one potential embodiment of a window shutter system 100 of the present invention while attached to a frame 200 that is attached to a wall 20 in accordance with the disclosed architecture. The window shutter base 500 is comprised of a frame 510, at least one edge 512, and a front surface 511, and also comprised of at least one shutter 520. The window base shutter 500 may be manufactured in any shape that allows it to be placed onto the frame 200 securely.

In the preferred embodiment, the base frame 510 is manufactured in the same shape as the frame 200 in order for the fasteners 216, 312, 532 to align to secure the window shutter base 500 to the frame 200. The edges 512 of the window shutter base 500 are what the side surfaces 612 of the window shutter cover 600 connect with. The window shutter base 500 may be comprised of at least one shutter 520 located on the front surface 511. The shutters 520 may be oriented in any fashion known in the art. The window shutter base 500 may be comprised from a plurality of materials such as but not limited to: wood, metal, plastic, etc.

The window shutter base 500 may further be comprised of indicia located on the window shutter base 500 such as but not limited to: words, symbols, flags, designs, logos, phrases, numbers, etc. The differentiating indicia and designs of the system 100 allow a user to customize the system 100 in any way they choose.

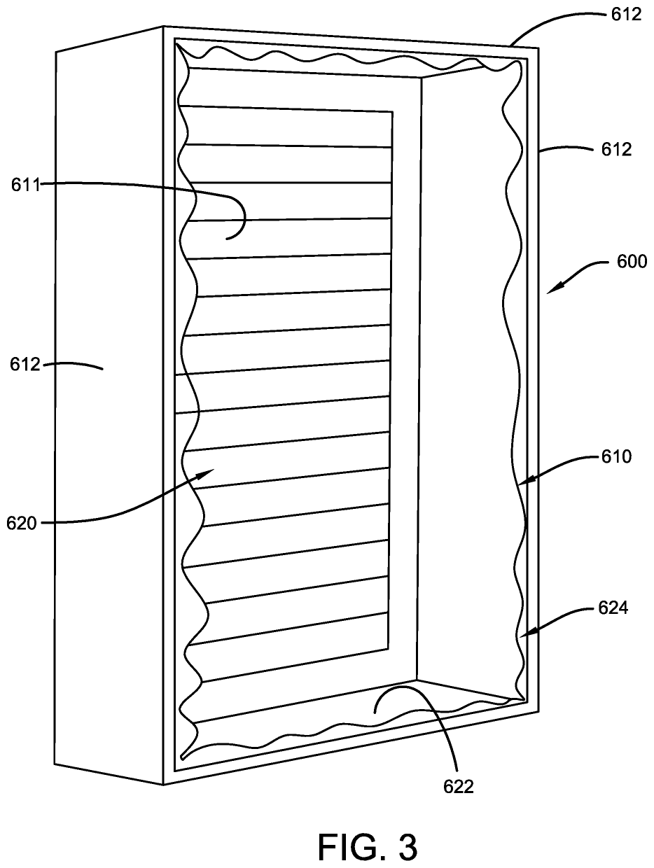

FIG. 3 illustrates a rear perspective view of a window shutter cover 600 of one potential embodiment of a window shutter system 100 of the present invention in accordance with the disclosed architecture. The system 100 is further comprised of a window shutter cover 600 further comprised of a frame 610, a front side 611, at least one side surface 612, at least one shutter 620, an inside surface 622, and at least one fastener 624. The window shutter cover 600 is fastened over/to the window shutter base 500 in order to allow for an even further customizable and convenient shutter system 100. The frame 610 is further comprised of at least one fastener 624 that is located on the inside surface 622 of the window shutter cover 600. These fasteners 624 fasten to the to the window shutter base 500. The fasteners 624 allow for easy attachment/detachment of the window shutter cover 600. The fasteners 624 may be any fasteners known in the art such as but not limited to: hook and loop, snap button, magnetic, adhesive, tongue and groove, ridges, etc.

The side surfaces 612 and the front surface 611 may be comprised of any color or indicia known in the art. There are a plurality of indicia that may be used such as but not limited to: flags, symbols, shapes, logos, words, numbers, etc. Further, the window shutter cover 600 may be comprised of any material known in the art such as but not limited to: wood, plastic, metal. In the preferred embodiment, the material is weatherproof and UV resistant to allow the window shutter cover 600 to last longer in adverse weather conditions. The cover 600 may be any shutter style, shape, and configuration known in the art.

The front surface 611 is further comprised of at least one shutter 620 that is preferably a vertical or horizontal shutter. The shutters can be in any orientation known in the art and are preferably made from the same weatherproof UV-resistant material as the rest of the window shutter cover 600. The shutters 620 further may be any shape known in the art, or be comprised of any indicia or color known in the art.

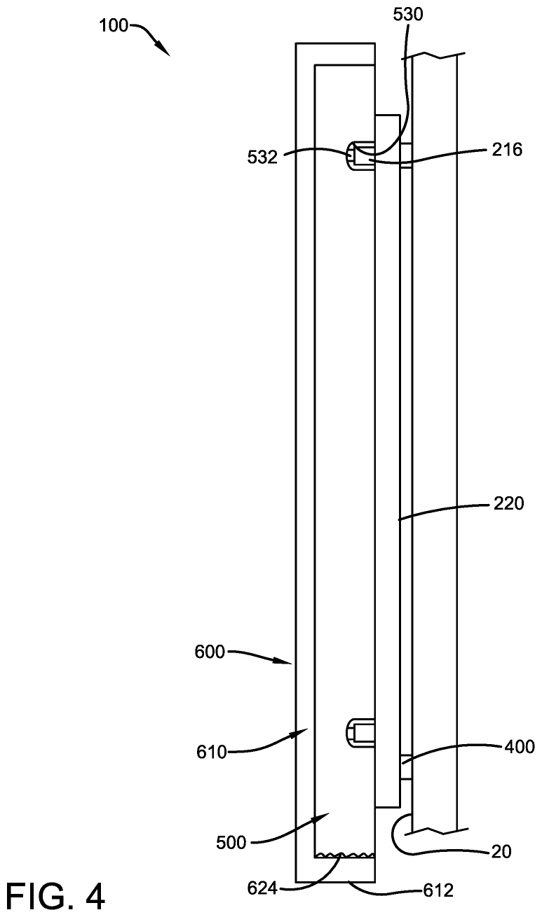

FIG. 4 illustrates a side view of a frame 200 of one potential embodiment of a window shutter system 100 of the present invention while attached to a wall 20 in accordance with the disclosed architecture. In the preferred embodiment, the frame 200 is mounted to the wall 20 via at least one mounting fastener 400 that is attached to the wall 20 and the rear surface 220 of the frame 200. The mounting fasteners 400 may be any fastener known in the art that is suitable to fasten the system 100 to the wall 20 such as but not limited to: nut and bolt, screw, nail, anchor, pin, etc. The window shutter base 500 is further attached to the frame via at least one fastener 532. These fasteners 432 connect to the reciprocating fasteners 216 located on the frame 200. The fastener 532 is further located in the recessed area 530 of the window shutter base 500 allowing for the two fasteners 532, 126 to be attached with minimal effort.

The window shutter cover 600 is further attached to the window shutter base 500 via at least one fastener 624 located on the side surface 612 of the window shutter cover 600. The fastener 624 allows the user to be able to attach and detach the window shutter covers 600 with minimal effort. In one embodiment, the system 100 is comprised of only the window shutter base 500 that connects to the frame 200 and allows for the user to switch out the window shutter base 500 to customize their shutters. In a differing embodiment, the system has both the window shutter base 500 that attaches to the frame 200 and the window shutter cover 600 that attaches to the window shutter base 500. This allows a user to change out the window shutter cover 600 to customize their shutters.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “window shutter system” and “system” are interchangeable and refer to the window shutter system 100 of the present invention.

Notwithstanding the forgoing, the window shutter system 100 of the present invention and its various components can be of any suitable size and configuration as is known in the art without affecting the overall concept of the invention, provided that they accomplish the above-stated objectives. One of ordinary skill in the art will appreciate that the size, configuration and material of the window shutter system 100 as shown in the FIGS. are for illustrative purposes only, and that many other sizes and shapes of the window shutter system 100 are well within the scope of the present disclosure. Although the dimensions of the window shutter system 100 are important design parameters for user convenience, the window shutter system 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A window shutter system comprising:
a frame comprised of a member and a mounting fastener;
a base comprised of a frame, a shutter, and a recessed area; and
a window shutter cover comprised of a frame and a shutter.

2. The window shutter system of claim 1, wherein the member is comprised of a vertical member.

3. The window shutter system of claim 1, wherein the member is comprised of a horizontal member.

4. The window shutter system of claim 1, wherein a top surface of the member is comprised of a fastener.

5. The window shutter system of claim 1, wherein the mounting fastener is positioned on a rear surface of the member.

6. The window shutter system of claim 1, wherein the shutter is comprised of a vertical shutter.

7. The window shutter system of claim 1, wherein the window shutter cover is positioned on the base.

8. A window shutter system comprising:
a frame comprised of a member;
a mounting fastener positioned on a rear surface of a member;
a first fastener positioned on a front surface of the member;
a base comprised of a frame, a shutter, and a recessed area comprised of a second fastener positioned within the recessed area; and
a window shutter cover comprised of a frame and a shutter.

9. The window shutter system of claim 8, wherein the first fastener is comprised of a hook and loop fastener, a magnetic fastener, a snap button fastener, an adhesive fastener, a nut and bolt fastener, or a tongue and groove fastener.

10. The window shutter system of claim 8, wherein the second fastener receives the first fastener.

11. The window shutter system of claim 8, wherein the shutter is comprised of a horizontal shutter.

12. A window shutter system comprising:
a frame comprised of a member;
a mounting fastener positioned on a rear surface of a member;
a first fastener positioned on a front surface of the member;
a base comprised of a frame, a shutter, and a recessed area comprised of a second fastener positioned within the recessed area; and
a window shutter cover comprised of a frame, a shutter, and a third fastener positioned on an inside surface of the window shutter cover.

13. The window shutter system of claim 12, wherein the base is comprised of a first edge.

14. The window shutter system of claim 12, wherein the window shutter cover is comprised of a second edge.

15. The window shutter system of claim 12, wherein the base is comprised of an indicia.

16. The window shutter system of claim 12, wherein the third fastener is comprised of a hook and loop fastener, a snap button fastener, a magnetic fastener, an adhesive fastener, a tongue and groove fastener, or a ridge.

17. The window shutter system of claim 12, wherein the member is comprised of a vertical member.

18. The window shutter system of claim 12, wherein the member is comprised of a horizontal member.

19. The window shutter system of claim 12, wherein the shutter is comprised of a horizontal shutter.

20. The window shutter system of claim 12, wherein the window shutter cover is positioned on the base.
